(19) United States
(12) Patent Application Publication
(10) Pub. No.: US 2009/0043771 A1
(43) Pub. Date: Feb. 12, 2009

(54) SYSTEMS, METHODS AND COMPUTER PRODUCTS FOR ENSURING DATA INTEGRITY OF A STORAGE SYSTEM

(75) Inventors: Jason F. Basler, Los Gatos, CA (US); Vo A. Cao, San Jose, CA (US); Robert W. Riordan, III, Santa Cruz, CA (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/836,203

(22) Filed: Aug. 9, 2007

(51) Int. Cl. G06F 17/30

(52) U.S. Cl. 707/8; 707/E17.001

(57) ABSTRACT

Systems, methods, and computer products for ensuring data integrity of a storage system. Exemplary embodiments include a method for ensuring data integrity in a storage system, the method including creating a data set using a repeatable pattern to establish expected values, storing the data set into the storage system using a defined interface of the system, extracting the data from the storage system using a defined interface of the system and comparing the extracted data against the expected values established by the known pattern.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to data storage systems, and particularly to systems, methods, and computer products for ensuring data integrity of a storage system.

2. Description of Background

When testing any data storage system, data integrity needs to be maintained from data storage to extraction. Typically, data copies are compared before data storage and after extraction. The following sequence can be implemented: 1) A Primary Data set is created; 2) a second copy of the data set is created; 3) The data sets are stored into a storage system using a defined interface of the system; 4) the primary copy of the data set is removed from the system; 5) the data is extracted from the storage system using the defined interface of the system; and 6) a byte by byte comparison is performed on the second copy from step 2 to the extracted copy from step 5. The above-described technique requires extra storage to maintain the additional copy of the data, which can be impractical when testing large volumes of data. In addition, significant extra time is required to create the second copy in step #2.

What is needed is a system and method that can be used to assist with testing data integrity of a storage system using a verifiable data format that is not excessively reduced by the compression mechanism(s) built into the storage system.

### SUMMARY OF THE INVENTION

Exemplary embodiments include a method for ensuring data integrity in a storage system, the method including creating a data set using a repeatable pattern to establish expected values, storing the data set into the storage system using a defined interface of the system, extracting the data from the storage system using a defined interface of the system and comparing the extracted data against the expected values established by the known pattern.

Further exemplary embodiments include a storage system for ensuring data integrity, the storage system including a computing device having a memory, processes residing in the memory, the processes having instructions to create a data set using a repeatable pattern to establish expected values, wherein the data set is generated in 512 byte blocks of characters, wherein a <sequence number> includes 22 bytes, a <repeating pattern> includes 468 bytes, and a <sequence number repeated> includes 22 bytes, generate a compression defeating data block from the data set using the repeatable pattern, define a permutation P(b) to generating the repeatable pattern, wherein b is a generator, and wherein b can be raised to the power j, an integer from 1 to 256, store the data set into the storage system using a defined interface of the storage system, extract the data from the storage system using a defined interface of the system, compare the extracted data against the expected values established by the known pattern and remove the data set from the storage system.

System and computer program products corresponding to the above-zed summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that can be used against a storage system to establish confidence in its ability to provide data integrity.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a flowchart of a method in accordance with exemplary embodiments;

FIG. 2 illustrates a storage system in accordance with exemplary embodiments; and

FIG. 3 illustrates a data file format in accordance with exemplary embodiments.

The detailed description explains the preferred embodiments of the invention, together with advantages and features, by way of example with reference to the drawings.

### DETAILED DESCRIPTION OF THE INVENTION

In exemplary embodiments, a technique of generating pseudo-random test data implemented for the testing of storage systems. The pseudo-random test data allows the integrity of data to be verified after a round-trip (store and restore) through the storage system. In exemplary embodiments, the systems and methods described herein can be implemented for testing storage systems with built-in compression. Tape drives with built-in data compression are an example of such a storage system. Normal pattern data compresses down to almost nothing, but the pseudo-random test data resists compression and allows for better test workloads. In exemplary embodiments, a control that adjusts the degree of apparent randomness in the test data that allows variations of the test data to be created, which respond differently to the subsystems built-in compression. As discussed above, a test method applies techniques of generating pseudo-random test data to the purpose of testing storage systems with built-in compression. Furthermore, the systems and methods described herein provide a control for the test method that varies the degree of randomness for the purpose of creating realistic data sets to drive through the storage system. Further, a control is provided which varies the extent to which the permutation is applied to the pattern block to effect the degree to which pattern block is transformed to apparent randomness. It is further appreciated that in exemplary embodiments, the systems and methods described herein generate a type of test data referred to as pseudo-random data.

In exemplary embodiments, the systems and methods described herein create data using a pattern format that can be verified without maintaining a copy of the data. By using a known repeating pattern when creating data, data integrity following extraction can be attained by comparing the extracted data against the known pattern. In exemplary embodiments, the pattern used in the data can be compressed close to 100%. Conversely, when the transformation to pseudo-random data is applied in full force, typical compression methods respond with negative compression. In other words, the data size grows after compression. A typical secondary goal of storage system testing is loading the system with significant amounts of data. However, pattern data, which is easily compressed, makes loading the storage system with significant amounts of data very inefficient.

In exemplary embodiments, data integrity can be tested by introducing controlled randomness to the pattern that is written to the data file. This controlled randomness can reduce the effectiveness of the storage system compression, but retains the characteristic of being 100% verifiable following extraction. With reduced effectiveness of compression, the size of the stored data does not shrink from its original size. Furthermore, the degree to which the compression is defeated can be easily adjusted through a parameter to the processes that implement this method.

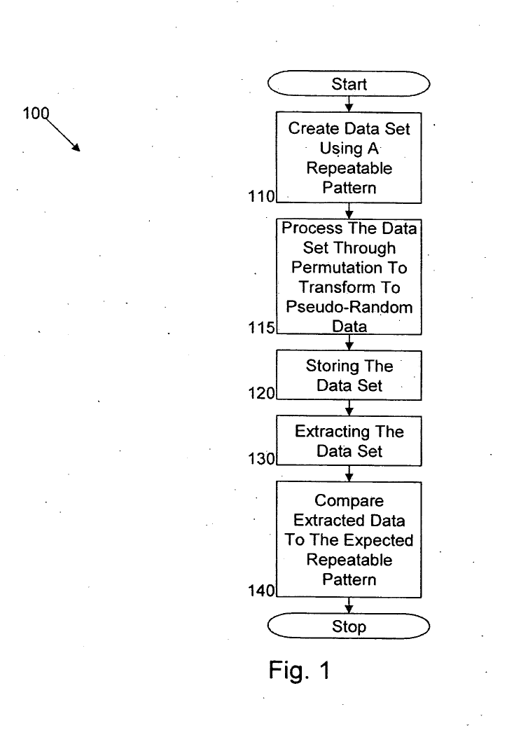

Turning now to the drawings in greater detail, FIG. 1 illustrates a flowchart for an exemplary method 100 in accordance with exemplary embodiments. As further described herein, the exemplary method 100 includes: 1) creating a data set using a repeatable pattern at step 110 (the dataset can be stored in temporary local storage, or directly to the storage system under test as it is generated); 2) processing the data set through a permutation to transform it to pseudo-random data at step 115; 3) storing the data set into the storage system using a defined interface of the system at step 120 (optionally, the original data can be removed from temporary local storage after storage. It is appreciated that the data under test that is stored remains in the storage system.); 4) extracting the data from the storage system using a defined interface of the system at step 130; and 5) comparing the extracted data against the expected values established by the known pattern at step 140.

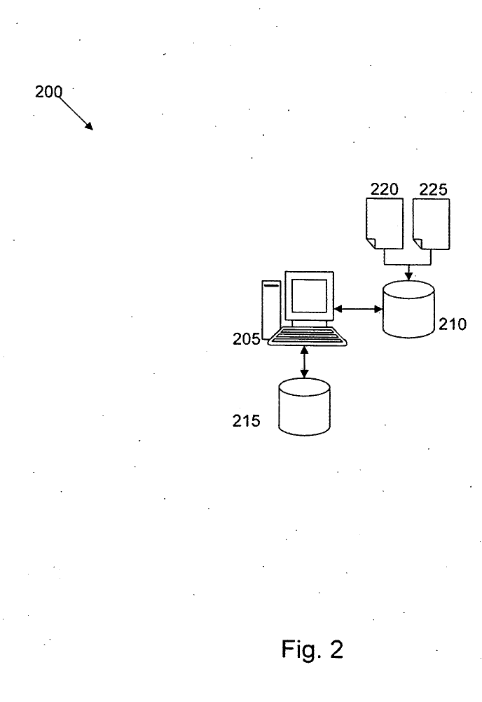

FIG. 2 illustrates a storage system 200 in accordance with exemplary embodiments. In exemplary embodiments, the system 200 includes a processing device 105 such as a computer, which includes a storage medium or memory 210. The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 210 may incorporate electronic, magnetic, optical, and/or other types of storage media. Note that the memory 210 can have a distributed architecture, where various components are situated remote from one another, but can be accessed by the processing device 205.

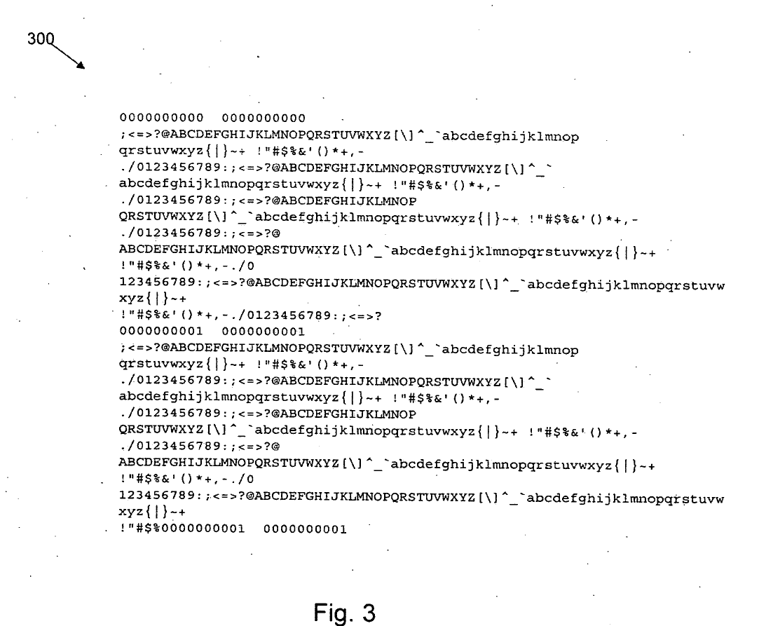

A data repository 215 is coupled to and in communication with the processing device 105. The system 200 can further include a first process 220, which can be referred to as crefile, which generates data files in the known pattern format. The system 200 can further include a second process 225, which can be referred to as cmpfile, which verifies that a file conforms to the pattern format. The first and second processes 220, 225 can reside in the memory 210. In exemplary embodiments, both processes work from the following parameters: filename; size of file (specified with B, K, M, or G suffix); size modifier (+|−1 through 511 bytes) used to modify the number of bytes in the final block of data, and a pseudo-randomness control used to specify whether a high, medium, low, or none degree of apparent randomness is applied. In exemplary embodiments, the pattern file uses the following format generated in 512 byte blocks of characters: <sequence number> 22 bytes; <repeating pattern> 468 bytes; and <sequence number repeated> 22 bytes. As an example, a command “crefile file1 1 k” can generate two blocks worth of data as shown in FIG. 3, which illustrates a data file format 300 in accordance with exemplary embodiments. In the example illustrated, no randomness has been introduced to the data filed.

The data file format 300 as illustrated in FIG. 3 has several characteristics. For example, the sequence number guards against a common type of data integrity problem in which the storage system mixes the ordering of data that can go undetected when using a repeating pattern format of data without this type of protection. Furthermore, the above-identified program can be modified to write data in binary format rather than text.

In exemplary embodiments, a simple method used for generating the repeating pattern portion of the data file is replaced with a method that generates seemingly random blocks of data. The apparent randomness of the data is the characteristic that prevents compression methods from reducing the size of the data. In addition to creating seemingly random data, the following requirements are also met to maintain the existing capabilities of the processes 220, 225: 1) data must be verifiable without maintaining an original copy, which is accomplished because the data file is identical every time it is generated; 2) identical data is generated regardless of which operating system and hardware type the processes 220, 225 are running; 3) the method allows for creation of data sets of different sizes; 4) sequence numbers must be used to avoid not detecting data corruption due to re-ordering of data blocks (the methods described herein create every block unique, so the need to mark the blocks with the sequence number is not needed); and 5) the size of the final block can be modified to add or remove bytes.

As discussed above, a compression defeating pattern block is generated. The sequence number of the current block being written is processed through the following algorithm to result in a sequence of characters. However a preliminary discussion immediately follows to explain precisely the correspondence of the sequence number to the block generated.

Since 257 is a prime, the non-zero elements modulo 257 (i.e., the numbers 1 through 256, taken mod 257) form a cyclic multiplicative group. As a consequence, taking a generator of this group (call it b for now) and raising it to the various powers 1, 2, 3, . . . , 256, taken mod 257 yields 256 different values (namely 1, 2, 3 . . . , 256 in some other (seemingly random) order. This process can be iterated by taking this new sequence as another sequence of powers to raise the generator b to (mod 257). Each iteration can then be used to generate 256 characters to write to a file. With 256 such iterations, a File with 256*256=65536 characters (64 K) is obtained. Given the way the characters in the file are generated, the file resists compression. By adjusting some parameters, it is possible to modify the compressibility of the file to some extent. In addition, files of sizes other than 64K can be generated by altering the number of iterations of the type described above, up to a limit (see discussion in the following paragraph of the order of the P(b) permutation).

It is appreciated that the process described above is essentially determined by the permutation, P(b), defined by transforming an integer j to the result of raising b (the generator) to the power j (mod 257). The result of raising this particular permutation to higher powers of itself gives rise to the different orderings of the integers 1 to 256, which, in turn, determine the characters that make up the file being generated. The order of this permutation is significant because the lowest positive power of the permutation returns to the identity. Regardless of the power, it determines when the pattern repeats. For example, if n is the lowest power, then raising P(b) to the powers 0, 1, . . . , n−1, results in distinct orderings of the integers 1 to 256, after which the pattern repeats: (i.e., raising P(b) to the nth power is the same as raising it to the 0 power, raising it to the n+1st power is the same as raising it to the first power and so on). The lowest power, n, such that P(b) raised to the nth power is the identity may depend on the generator b, among other things. Finally, to relate this back to sequence number as discussed above, it can be said that each sequence number corresponds to 2 consecutive iterations of the P(b) permutation, each of which gives rise to a block of 256 characters (so that the 2 together give the 512 block). In general, the 512 block is not generated directly in one step because the primality of the block size+1 is a requirement of the above-described algorithm, and 257=256+1 is prime, while 513=512+1 is not, being the product to 3 and 171.

In exemplary embodiments, by varying the choice of the generator b, the precise content of the file generated can be altered while maintaining the desired “randomness”. However, it is appreciated that not all choices of generator are equally “good” (i.e., they can all give rise to permutations of comparable order, or do some give rise to “degenerate” permutations of low order). However, in exemplary embodiments, it is sufficient for now just have just one “good” generator available for use, and given that choice of generator, the file's content is completely determined by the number of blocks generated. It is appreciated that the algorithm meet the requirements of the processes 120, 125 that the data be verifiable without maintaining an original copy and the sequence numbers are used to avoid not detecting data corruption due to re-ordering of data blocks. It is further appreciated that for allowing the creation of data sets of different sizes, block uniqueness is guaranteed as long as number of 256-byte blocks generated does not exceed the order of the P(b) permutation as discussed in the preceding paragraph.

It is appreciated that there is an apparent limitation in the number of blocks that can be generated before pattern recognition occurs. In exemplary embodiments, a method to overcome the apparent limitation in the number of blocks that can be generated before patter repetition occurs, primes larger than 257 can be implemented. The use of such primes would be expected to make possible the generation of much larger files before encountering the pattern repetition that results from the number of blocks generated exceeding the order of the P(b) permutation. However, it is appreciated that there may exist intrinsic hardware limitations putting an effective upper bound to the size of the “window” inside of which any real-world compression algorithm can exploit pattern repetition. As such, it is further appreciated that the methods described herein implement algorithms that stay below high window sizes.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for ensuring data integrity in a storage system, the method comprising:
creating a data set using a repeatable pattern to establish expected values;
storing the data set into the storage system using a defined interface of the system;
extracting the data from the storage system using a defined interface of the system; and
comparing the extracted data against the expected values established by the known pattern.

2. The method as claimed in claim 1 further comprising generating a compression defeating data block from the data set using the repeatable pattern.

3. The method as claimed in claim 2 further comprising defining a permutation P(b) to generating the repeatable pattern, wherein b is a generator.

4. The method as claimed in claim 3 further comprising raising the generator b to the power of j to determine characters generated in the data set, wherein j is an integer ranging from 1 to 256.

5. The method as claimed in claim 4 wherein the data set is generated in 512 byte blocks of characters, wherein a <sequence number> includes 22 bytes, a <repeating pattern> includes 468 bytes, and a <sequence number repeated> includes 22 bytes.

6. A storage system for ensuring data integrity, the storage system comprising:
a computing device having a memory;
processes residing in the memory, the processes having instructions to:
create a data set using a repeatable pattern to establish expected values, wherein the data set is generated in 512 byte blocks of characters, wherein a <sequence number> includes 22 bytes, a <repeating pattern> includes 468 bytes, and a <sequence number repeated> includes 22 bytes;
generate a compression defeating data block from the data set using the repeatable pattern;
define a permutation P(b) to generating the repeatable pattern, wherein b is a generator, and wherein b can be raised to the power j, an integer from 1 to 256;
store the data set into the storage system using a defined interface of the storage system;
extract the data from the storage system using a defined interface of the system;
compare the extracted data against the expected values established by the known pattern; and
remove the data set from the storage system.
